(19) United States
(12) Patent Application Publication
(10) Pub. No.: US 2007/0071859 A1
(43) Pub. Date: Mar. 29, 2007

(54) Flexible plastic juice strainer

(76) Inventor: Vivienne Roumani Denn, New York City, NY (US)

Correspondence Address: Frank Cozzarelli Jr., Esquire;Cozzarelli Law Firm, 727 Joralemon Street, Belleville, NJ, 07109, US

(21) Appl. No.: 11/234,855

(22) Filed: Sep. 26, 2005

(51) Int. Cl. A23L 2/02

(52) U.S. Cl. 426/489

(57) ABSTRACT

A novel flexible plastic film juice strainer having length, width, edges, two sides, and containing at least one perforation of sufficient size such that when said flexible plastic film juice strainer is wrapped around a citrus fruit section and manually squeezed, seeds and solids from the citrus fruit section are intercepted and retained by said flexible plastic film juice strainer and the citrus juice flows through the perforation. The flexible plastic film juice strainer with perforations maintains its strength and flexibility.

### FIELD OF THE INVENTION

The present invention relates to a method and apparatus for the manual separation of pits and solids from juice as squeezed from citrus fruits, such as lemons, limes, oranges and others. More specifically, the invention is an apparatus and method of manually extracting juice from a citrus fruit by means of a disposable, perforated, flexible, plastic film when wrapped around the citrus fruit, and squeezed said apparatus retains the seeds, pits and solids, while protecting the person extracting the juice and others nearby from being sprayed by the juice.

### BACKGROUND OF THE INVENTION

Various approaches have been taken to separate juice from fruits and vegetables or to package fruits and vegetables.

Cheesecloth and similar woven fabric coverings have been used to extract juice from citrus fruit. The current invention is less costly than cheesecloth to use, is more convenient for the user because of the ease of implementation and disposal, and is more hygienic because of minimal contact with the juice and citrus fruit.

Perforated flexible film has been used in a variety of food and non-food applications, but they are not employed for the purpose and method of the present invention. Some of the patents considered follow.

U.S. Pat. No. 5,537,918 to Patel et al. discloses non-disposable mechanical devices for extracting juice. Such devices are not relevant to this invention because they are mechanical devices.

U.S. Pat. No. 5,171,593 to Doyle discloses a method of wrapping fruits and vegetables or other articles with a perforated plastic sheet that permits the passage of air for ventilation, but does not teach anything about the passage of liquid.

U.S. Patent Application 20030035868 to Coulter et al. discloses a method for producing food product packages with a perforated plastic wrap that permits the passage of air for ventilation, but not the passage of liquid.

U.S. Pat. No. 4,321,756 to Mosely discloses a device in which a perforated plastic bag is placed inside another bag, and the two bags are used as a sling as a means of removing water from the surface of the vegetables.

Perforated flexible film is also used in absorbent devices as a means of allowing liquid to pass into an absorbent layer in order to keep a facing layer relatively dry.

U.S. Pat. No. 3,945,386 to Anczurowski et al. discloses a disposable diaper employing such a concept.

U.S. Pat. No. 5,674,211 to Ekdahl also discloses the use of a perforated plastic film that serves as the top sheet of an absorbent disposable article.

U.S. Pat. No. 5,055,332 to Rhodes et al. discloses the use of one or more perforated plastic films to permit liquid from meat or poultry products to pass through to an absorbent layer to keep meat essentially dry.

None of the aforementioned applications of perforated plastic flexible films addresses the purpose of the current invention, which is to remove juice from a lemon, a lime, an orange or similar citrus fruit by utilizing a disposable perforated plastic flexible film that when wrapped around the citrus fruit and squeezed retains the pits and solids and allows the juice to be applied to the food while protecting the squeezer and those nearby from being sprayed by the juice.

With the above limitations of the current approaches in mind, it is an object of the present invention to provide a method and apparatus that when squeezing juice from a lemon, a lime, an orange or similar fruit on to food the seeds, pits and solids are kept from entering the juice collection container or from going on to food. The usual way to keep seeds from leaving the fruit with the juice is to employ a mechanical juicer of any of several designs, in which the seeds are caught in a rigid non-disposable device with holes that requires cleaning, or to wrap the fruit in cheesecloth or a similar woven fabric material and squeeze the juice through the cloth. Then after separation of juice and solids the juice is used as desired.

An object of the present invention is to provide a disposable, flexible plastic juice strainer containing at least one but preferably a plurality of perforation that permits the juice from a wedge or slice of a lemon, a lime, an orange or similar fruit to pass through but retains the seeds and solid particles.

Another object of the present invention is to provide a method and apparatus that permits the juice from a wedge or slice of a lemon, a lime, an orange or similar fruit to pass through but retains the seeds and solid particles that is inexpensive.

Another object of the present invention is to provide a method and apparatus that permits the juice from a wedge or slice of a lemon, a lime, an orange or similar fruit to pass through but retains the seeds and solid particles that is disposable.

Another object of the present invention is to provide a method and apparatus that permits the juice from a wedge or slice of a lemon, a lime, an orange or similar fruit to pass through but retains the seeds and solid particles that is easy to use.

Another object of the present invention is to provide a method and apparatus that permits the juice from a wedge or slice of a lemon, a lime, an orange or similar fruit to pass through but retains the seeds and solid particles that keeps the juice from spraying people near the user.

Another object of the present invention is to provide a method and apparatus that permits the juice from a wedge or slice of a lemon, a lime, an orange or similar fruit to pass through but retains the seeds and solid particles that is in minimal contact with the citrus fruit and is hygienic.

Another object of the present invention is to provide a method and apparatus that permits the juice from a wedge or slice of a lemon, a lime, an orange or similar fruit to pass through but retains the seeds and solid particles that does not require the collection of the juice in a container and then used as desired.

The objects, advantages and features of the present invention are readily apparent from the following description of the preferred embodiment(s) for carrying out the invention.

### SUMMARY OF THE INVENTION

I have invented a juice strainer of flexible plastic film having length, width, edges, and two sides for separating juice from pits and solids from citrus fruit such as lemons, limes, oranges and similar fruit comprising a flexible plastic film having at least one perforation through said flexible plastic film within the active length and width and thickness of the film wherein pits and solids are retained by the flexible plastic film. The flexible plastic film juice strainer is unique, economical, easily manufactured, hygienic to use and is disposable.

### DESCRIPTION OF THE PREFERRED EMBODIMENT(S)

The invention claimed here is a sanitary disposable plastic juicer containing at least one perforation and preferably a plurality of perforations that permit(s) the juice from a slice or wedge of lemon, lime, orange or similar fruit to pass through, but retaining the seeds and solids within. The invention employs a disposable, flexible plastic film, with a weight or thickness similar to that used in sandwich, trash or storage bags that contain(s) at least one and preferably a plurality of perforations that permits juice but not seeds and solids to pass through said film. A piece of disposable, flexible, plastic film sufficient in size to enclose a slice, a wedge or one-half of a lemon, a lime, an orange or similar fruit is wrapped around the fruit section. The fruit is manually squeezed, permitting juice to pass through the film through said perforations through said film. The used fruit is then discarded with the plastic film. The perforated plastic film employed in the invention can be in the form of a continuous film with perforations from which pieces can be cut or torn, or individual sheets.

Conventional methods used to squeeze juice from a lemon or similar fruit require either cleaning a non-disposable “squeezer” or cutting and tying cheesecloth or similar woven fabric. This invention utilizes a piece of an inexpensive, flexible, plastic film with perforation(s) that can be discarded with the used fruit, enabling easy and hygienic use by the individual.

The present invention achieves the sieving action by providing flexible plastic film manufactured by any commonly known method(s) with perforations of such size, shape, location and spacing as is consistent with the underlying plastic polymers' properties. Such perforations provide a film with the way to provide a juice free of pits and solids. Various techniques may be used to achieve control of the perforations, including but not limited to, die cutting, air pulse, needle punch, laser pulse and internal formulation with gas-producing additives. Perforations thus created may range from highly regular shapes in precise positions having distinct edges to “burst” structures with ragged edges and more or less random placement and size.

The size, number, structure, type and location of the perforations are determined on the basis of the material of construction's toughness and physical properties, subject to the requirement to provide the sieving action as defined above; further constrained by manufacturing cost effectiveness. The number and size of perforations are limited by the decrease in tensile strength and tear resistance of each material, and not by any theory of more or less effective hole-density or hole-frequency. Indeed, in the present invention the general limit is reached when the film polymer remaining around perforations is just sufficient to sustain the requisite strength for handling and use. Even a single perforation in about one-half square foot of flexible plastic film provides some straining of the juice, although, a plurality of film perforations is more effective than other methods of straining.

General film dimensions and material considerations have been well presented in U.S. Pat. No. 4,450,849 and are incorporated here by reference. Thus, flexible plastic juice strainers of the present invention are to be prepared from flexible plastic film widths from about three (3) inches and thicknesses of about 0.5 mil to about 5 mil (0.0125 mm to about 0.125 mm).

Plastic materials known in the art as meeting these requirements of user tolerance, strength and dimensional control can be used for the construction of the flexible plastic film of the present invention without limiting the invention to such materials. Polymeric materials used for the flexible plastic film, include but are not limited to polyolefins, polyesters, polyamides (nylon) and poly(tetrafluoroethylene) (Teflon®). Polymeric materials used for the flexible plastic film may also be of the self-adhering also known as the “cling” type of film.

The following examples illustrate embodiments of the present invention without limiting the invention thereby.

### EXAMPLE 1

A section of film approximately 3 inches square was cut from a plastic film having perforations of about one-eighth inch in diameter spaced approximately 3/16 inch apart. The square sheet was placed over and completely enclosing one-half a lemon. The lemon half was manually squeezed and juice passed freely through the perforations, while retaining the pits and solids. The film piece and the used lemon half were then discarded. No lemon juice came in contact with the squeezer's hands.

### EXAMPLE 2

A commercial polyamide flexible polymer film of about three (3) inches by 2 mil cross-section was perforated at room temperature on a ¼ inch triangular pitch along the centerline with a ⅛^{th} diameter awl. The square sheet was placed over and completely enclosing one-half a lemon that was manually squeezed and juice passed freely through the perforations, while retaining the pits and solids. The film piece and the used lemon half were then discarded. No lemon juice came in contact with the squeezer's hands. The flexible polymer film retained its flexibility and strength and did not tear apart during use.

### EXAMPLE 3

A section of film without perforations was cut from commercially available SARAN® wrap of the “cling” type film and was perforated with a heated awl leaving perforations about one-eight inch in diameter and were spaced on a square pitch pattern. The square sheet was placed over and completely enclosing one-half a lemon that was manually squeezed and juice passed freely through the perforations, while retaining the pits and solids. The film piece and the used lemon half were then discarded. No lemon juice came in contact with the squeezer's hands. The flexible polymer film did not tear apart during use and the film piece retained its flexibility and strength.

The flexible plastic juice strainer is of sufficient dimensions to be able to be wrapped around a citrus fruit section in which two or more perforations are spaced at any distance but are preferably in a regular grid pattern with perforations having a spacing of ¼ inch between the perforations. The perforations may also be in a repeating triangular, square or rectangular pattern.

A number of advantages relating to the present invention of a disposable, flexible polymer juice strainer containing at least one perforation follow.

An advantage of the present invention is the disposable, flexible plastic juice strainer containing at least one perforation permits the juice from a wedge or slice of a lemon, a lime, an orange or similar fruit to pass through but retains the seeds and solid particles.

Another advantage of the present invention is the apparatus permits the juice from a wedge or slice of a lemon, a lime, an orange or similar fruit to pass through but retains the seeds and solid particles and is inexpensive.

Another advantage of the present invention is the method and apparatus permits the juice from a wedge or slice of a lemon, a lime, an orange or similar fruit to pass through but retains the seeds and solid particles and is disposable.

Another advantage of the present invention is the method and apparatus that permits the juice from a wedge or slice of a lemon, a lime, an orange or similar fruit to pass through but retains the seeds and solid particles and is easy to use.

Another advantage of the present invention is the method and apparatus that permits the juice from a wedge or slice of a lemon, a lime, an orange or similar fruit to pass through but retains the seeds and solid particles keeps the juice from spraying the user or people near the user.

Another advantage of the present invention is the method and apparatus that permits the juice from a wedge or slice of a lemon, a lime, an orange or similar fruit to pass through but retains the seeds and solid particles is in minimal contact with the citrus fruit and is hygienic.

Another advantage of the present invention is the method and apparatus permits the juice from a wedge or slice of a lemon, a lime, an orange or similar fruit to pass through but retains the seeds and solid and particles does not require the collection of the juice in a container for use as desired.

Alternate embodiments of practicing the invention but within the spirit thereof, will, in light of this disclosure, occur to persons skilled in the art. It is intended that this description be taken as illustrative only and not construed in any limiting sense except by the following claims.

I claim:

1. A flexible plastic film juice strainer having length, width, edges, two sides, and containing at least one perforation of sufficient size such that when said flexible plastic film juice strainer is wrapped around a citrus fruit section and manually squeezed, seeds and solids from the citrus fruit section are intercepted and retained by said flexible plastic film juice strainer and the citrus juice flows through the perforation.

2. A flexible plastic film juice strainer as defined in claim 1 wherein said flexible plastic film juice strainer is fabricated of polymeric material comprising a section about one square foot in area by about 0.0125 mm to about 0.125 mm in thickness with a plurality of perforations through said flexible plastic film juice strainer.

3. A flexible plastic film juice strainer as defined in claim 1 wherein said flexible plastic film juice strainer is constructed of polymeric material comprising a section of flexible plastic preferably about six inches to eight inches in length by about six inches to about eight inches in width and a thickness of about 0.0125 mm to about 0.125 mm with a plurality of perforations about ⅛ inch in diameter to about 3/16 inch in diameter with said perforations being about ¼ inch apart.

4. A flexible plastic film juice strainer as defined in claim 3 wherein said flexible plastic film juice strainer film is of sufficient dimensions to be able to wrap around a citrus fruit section in which a plurality of perforations are spaced in a repeating pattern but within the length and width of said flexible plastic film juice strainer.

5. A flexible plastic film juice strainer as defined in claim 3 wherein said flexible plastic film juice strainer wherein said repeating pattern of the perforations are in a repeating triangular, square or rectangular configuration.

6. A flexible plastic film juice strainer as defined in claim 1 wherein said flexible plastic film juice strainer is manufactured as a continuous sheet of flexible plastic film about 12 inches wide with perforations and about 500 square feet are rolled on to a cardboard tube about 12 inches long by about 1¾ inch diameter placed in a cardboard box having a sharp serrated blade from which said flexible plastic film juice strainer pieces can be cut or torn.

7. A flexible plastic film juice strainer as defined in claim 1 wherein said flexible plastic film juice strainer is either made of a self-adhering type flexible plastic film or a non-self-adhering type flexible plastic film.

8. A flexible plastic film juice strainer as defined in claim 1 wherein said perforations are formed by, but not limited to, methods utilizing, dies, air pulses, needle punches, laser pulses and internal formulations with gas-producing additives that burst to form said perforations.

9. A flexible plastic film juice strainer as defined in claim 1 wherein said flexible plastic film juice strainer is disposable.

10. A flexible plastic film juice strainer as defined in claim 1 wherein said flexible plastic film juice strainer is fabricated of polymeric materials that include but is not limited to polyolefins, polyesters, polyamides (nylon) and poly(tetrafluoroethylene) (Teflon®).

11. A flexible plastic film juice strainer as defined in claim 2 wherein said flexible plastic film juice strainer is fabricated of polymeric material preferably 0.5 square foot in area.

12. A flexible plastic film juice strainer as defined in claim 1 wherein the flexible plastic film juice strainer is of sufficient size to wrap around a citrus fruit section in which two or more perforations are preferably spaced about ¼ inch between the perforation edges.

13. A flexible plastic film juice strainer as defined in claim 1 wherein the flexible plastic film juice strainer is of sufficient size to wrap around a citrus fruit section in which three or more perforations in a repeating pattern.

14. A method of separating seeds and solids from a section or wedge of citrus fruit with a flexible plastic film juice strainer by:
a. wrapping and tightly securing a piece of said flexible plastic film juice strainer with perforations around a citrus fruit section,
b. manually squeezing the citrus fruit section,
c. forcing the juice from the section of citrus fruit to pass through the perforations of the flexible plastic film juice strainer on to food,
d. intercepting and retaining the seeds and solids from the juice of a citrus fruit section with said flexible plastic film juice strainer, and
e. disposing of the flexible plastic film juice strainer and the retained seeds and solids.

15. A method of separating seeds and solids from a section or wedge of citrus fruit as defined in claim 14 that is manual and easy to use.

16. A method of separating juice from a section of citrus fruit as defined in claim 14 that does not require a container to collect the juice separated from seeds and solids by said flexible plastic film juice strainer.
